(19) United States
(12) Patent Application Publication
(10) Pub. No.: US 2009/0164384 A1
(43) Pub. Date: Jun. 25, 2009

(54) Investment structure and method for reducing risk associated with withdrawals from an investment

(76) Inventors: Patrick J. Hellen, South Orange, NJ (US); Douglas F. Bateson, New York, NY (US); Michael H. Monforth, Ridgewood, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/054,662

(22) Filed: Feb. 9, 2005

(51) Int. Cl. G06Q 40/00

(52) U.S. Cl. 705/36 R

(57) ABSTRACT

This invention relates to a method for reducing risk associated with a withdrawal from an investment by determining an amount related to a liability or asset associated with the withdrawal and incorporating at least a portion of the amount into other liabilities or assets related to the investment. Further, the absolute value of the amount is amortized. Therefore, the effects of multiple withdrawals are balanced and reduced with time, thereby reducing the overall risk associated with withdrawals. Accordingly, withdrawals can occur more frequently, and a more liquid investment structure is provided.

### I. FIELD OF THE INVENTION

This invention relates to a method for reducing risk associated with a withdrawal from an investment by determining an amount related to a liability or asset associated with the withdrawal and incorporating at least a portion of the amount into other liabilities or assets related to the investment. Further, the absolute value of the amount is amortized. Therefore, the effects of multiple withdrawals are balanced and reduced with time, thereby reducing the overall risk associated with withdrawals. Accordingly, withdrawals can occur more frequently, and a more liquid investment structure is provided.

### II. BACKGROUND OF THE INVENTION

Under the principles of deferred compensation, an employer has an obligation to pay an employee an amount of money at a later time. This creates a liability on the employer's balance sheet. The employee may arrange to have this amount of money exposed to the returns of a particular fund (e.g., a bond fund, a stable value fund, or an S&P 500 fund). For instance, if the particular fund is an S&P 500 fund, the employer's liability to the employee will fluctuate with the S&P 500. In particular, if the S&P 500 increases in value by 8% in one year, the employer's liability to the employee also increases by 8%. Accordingly, the employer may choose to invest in investments that match the growth characteristics of its liabilities to the employee.

However, the returns on an employer's investment in funds, such as an S&P 500 fund, are taxable. Therefore, the employer needs to invest enough money in a fund or funds that will match its growing deferred compensation liability despite the taxes. For example, assume that an employer has $100 in deferred compensation liability that grows 10% in one year. At the end of the year, the liability is $110, but the employer is able to claim a deduction for the increased liability of $10. Assuming a tax rate of 40%, the employer's deduction saves it $4 on the $10 increase, causing a net effect of a $6 increase in deferred compensation liability. In order for the employer to meet this $6 increase, it must invest enough money in the right investment(s) to provide a net $6 return in one year. For example, assume that the employer invests in an S&P 500 fund that returns 10% in the year at issue, and that the employer is taxed at a rate of 40%. In this situation, the employer must invest $100 in the S&P 500 fund to obtain a net $6 return. That is, the $100 investment grows to $110, but the $10 increase is taxed at 40%, leaving a net increase of $6.

The capital expenditure required by employers ($100 in this example) to meet their growing deferred compensation liabilities when investing in taxable investments is unacceptably high. To reduce this capital expenditure, employers conventionally have purchased company owned life insurance (“COLI”) on the lives of their employees. In this scenario, the employer pays insurance premiums to the insurance company, which then invests the net premiums in investments, some or all of which, would be taxable absent the COLI arrangement. COLI reduces an employer's capital expenditures because the value of insurance policies grows on a tax-free basis. For example, assume again that the employer's deferred compensation liability is $100 and grows 10% in one year. At the end of the year, due to tax deductions, the net increase in the employer's net deferred compensation liability is $6. Now assume that a COLI investment grows 10% in the same year and that transaction costs associated with investing in COLI are negligible. In this situation, the employer only needs to invest $60 in COLI to achieve a $6 increase, as opposed to $100 in a taxable investment to achieve the same $6 increase.

As illustrated at item 101 in FIG. 1, the above-discussed COLI arrangement works well for deferred compensation liabilities and investments that both grow in the same market-volatile manner, such as equity funds, bond funds, balanced funds, and company stock. However, at item 102 in FIG. 1, where the employer has an obligation to an employee that grows in a relatively constant, non-volatile manner, such as a promise to pay a fixed return, or the return of a stable value fund, the above-discussed COLI arrangement is inadequate. In particular, if the employer's obligation is growing at a fixed or stable rate, and the employer's hedge investments are growing at a market-volatile rate, the employer may find itself in an unfavorable accounting position where the returns on its investments are more volatile than the reported obligations to its employees.

In response, employers have historically hedged their stably growing liabilities with short term investments, such as money market instruments, which also grow in a stable manner. However, this strategy is inadequate when the money markets have lower returns than the rate at which the employer's obligation is growing.

Accordingly, employers do not have an effective way to hedge their stably growing liabilities. Further, employers need to keep their investments relatively liquid, so that they can easily change investments from one fund to another to keep up with their changing liabilities.

### III. SUMMARY OF THE INVENTION

These problems are addressed and a technical solution achieved in the art by a method for reducing risk associated with a withdrawal from an investment. The method provides a novel stable value agreement, in which the agreement has a value, and the provider guarantees the value to the investor. Anytime a withdrawal from the investment occurs according to an embodiment of the present invention, a difference between a book value and an actual value of the withdrawal is incorporated as a component of the stable value agreement. This difference may be incorporated into the value of the agreement, and the absolute value of this difference is reduced over a period of time. Therefore, the potential liability to the stable value provider due to the withdrawal is blended into the value of the agreement and reduced with time, thereby reducing risk. By reducing the risks associated with withdrawals, the allowable frequency of withdrawals can be increased, and a more liquid investment structure is provided.

In the deferred compensation context, the present invention allows stable value providers to offer a stable value agreement to life insurance companies, while allowing the assets underlying the investments to remain relatively liquid. Consequently, employers now have a way to effectively hedge their stably growing liabilities while keeping their investments relatively liquid. Employers may then easily change investments from one fund to another to keep up with their changing liabilities.

### IV. BRIEF DESCRIPTION OF THE DRAWINGS

A more complete understanding of this invention may be obtained from a consideration of this specification taken in conjunction with the drawings, in which:

FIG. 1 illustrates the problem of effectively hedging liabilities that grow in a stable, non-volatile manner;

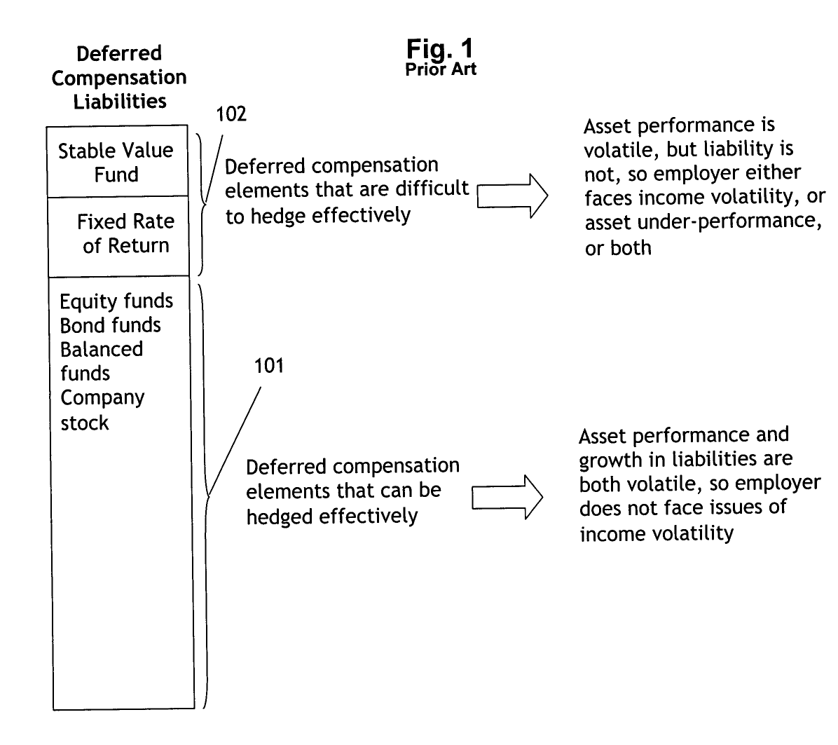

FIG. 2 illustrates the effect of a stable value agreement on an unstabilized market value portfolio; and

FIG. 3 illustrates an investment structure, according to an embodiment of the present invention.

### V. DETAILED DESCRIPTION OF THE INVENTION

Although this invention was created in response to problems in the deferred compensation context, persons having ordinary skill in the relevant art will appreciate that this invention applies to any investment context where withdrawals from an investment pose a risk.

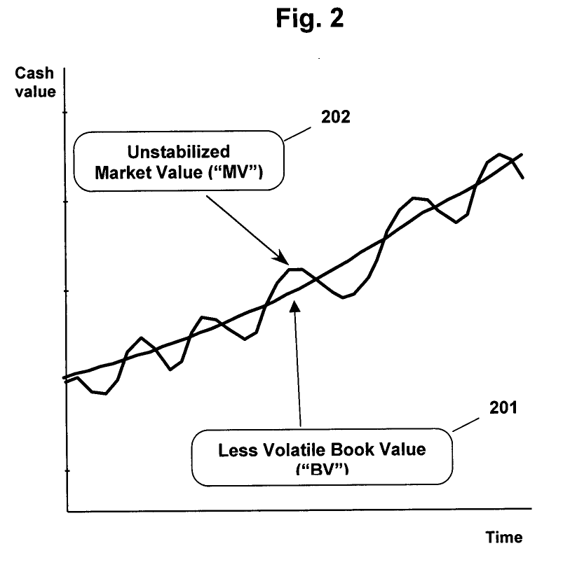

Turning now to FIG. 2, a brief explanation of stable value agreements is provided. In particular, a stable value agreement is an agreement in which a stable value provider guarantees to an investor a stable book value return 201 for an unstabilized market value 202 of one or more investments (“stable value portfolio” or “portfolio”). “Guaranteeing” book value means that if a predetermined event occurs, such as the investor executing a qualifying surrender of its life insurance policy as defined by the agreement, at a time when book value exceeds market value, the provider must pay the investor the difference between book value and market value. In return, the investor typically pays the provider a fee based upon the book value.

The reason stable value agreements have not previously been an attractive option for employers hedging their stably growing liabilities is because stable value providers have been unwilling to bear the risks faced as a result of excessive withdrawals from the underlying investments. Because the stable value provider is obligated to pay the difference between book value and market value (if positive) when a qualifying surrender of the life insurance policy takes place, excessive withdrawals can have the effect of substantially increasing the chance that a surrender will occur when book value exceeds market value. Further, withdrawals also reduce the stable value provider's incoming fees because less money is in the portfolio.

For a simple example, assume that the market value of a stable value portfolio is $100, book value is $120, and the employer withdraws $50. In the conventional arrangement, the market value then falls to $50, and the book value falls to $70. The stable value provider is now confronted with a worse ratio between market value and book value, which was $100/$120, or 0.83 before the withdrawal and is $50/$70, or 0.71 after the withdrawal. Further, the provider's absolute exposure or potential liability (book value minus market value) remained 20 both before the withdrawal ($120−$100=$20) and after the withdrawal ($70−$50=$20). However, the provider is only earning fees on $70, instead of $120. The net effect is that the provider's absolute exposure has become more “fixed,” and incoming fees have reduced. Therefore, risk has increased and income has decreased. Stated another way, because substantially less money remains in the portfolio and the portfolio has a lower market value to book value ratio, it is more unlikely that the market value will increase by $20 in a timely manner to reach the book value of $70. Accordingly, there is a much greater chance that the employer will effect a surrender when book value exceeds market value.

For these reasons, it has been very difficult to offer a stable value agreement when the assets underlying the stable value agreement need to remain liquid. Consequently, employers who are trying to match their investments with their changing liabilities and need to keep their investments liquid, have not had the opportunity to benefit from the volatility-reducing benefits of stable value agreements.

The present invention solves this problem by reducing the risk associated with withdrawals from an investment. An embodiment of the present invention achieves this result by providing a novel stable value agreement, in which the agreement has a value, and the provider guarantees the value to the investor. Anytime a withdrawal from the investment occurs, according to an embodiment of the present invention, a difference between a book value and an actual value of the withdrawal amount is incorporated as a component of the stable value agreement. This difference may be incorporated into the value of the agreement, and the absolute value of this difference is reduced over a period of time. Therefore, the potential liability to the stable value provider due to the withdrawal is blended into the value of the agreement and reduced with time, thereby reducing risk. By reducing the risks associated with withdrawals, the allowable frequency of withdrawals can be increased, and a more liquid investment structure is created.

In the deferred compensation context, the present invention allows stable value providers to offer a stable value agreement to life insurance companies, while allowing the assets underlying the investments to remain relatively liquid. Consequently, employers now have a way to effectively hedge their stably growing liabilities while keeping their investments relatively liquid. Employers may then easily change investments from one fund to another to keep up with their changing liabilities.

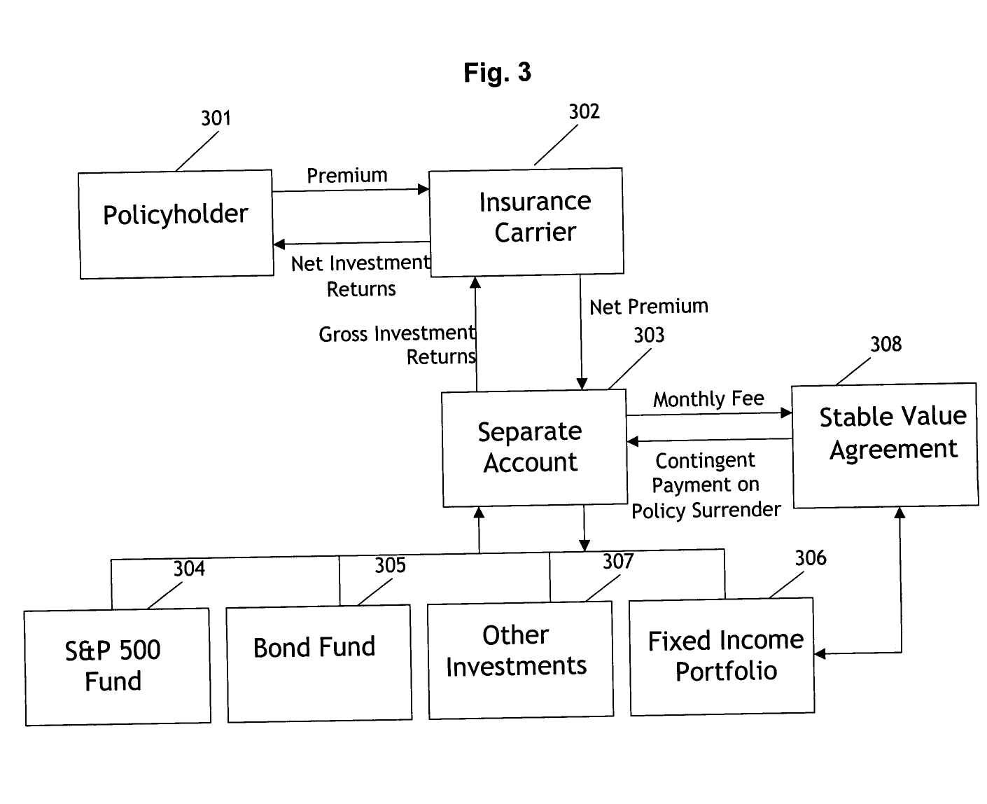

FIG. 3 illustrates an investment structure, according to an embodiment of the present invention. A policyholder 301 purchases an insurance policy, such as a company owned life insurance (“COLI”) policy or a bank owned life insurance policy (“BOLI”) from an insurance carrier 302. Some of the premium paid by the policyholder 301 is paid to cover premium taxes, fees to the insurance carrier 302, and other policy loads known in the art. The insurance carrier 302 invests the net premium payment in investments contained within a separate account 303. The separate account 303 is an account separate from the insurance carrier's 302 general account and, therefore, provides a level of security for the policyholder in the event that the insurance carrier defaults. In other words, the separate account 303 is protected from creditors of the insurance carrier 302 in the event of default.

Examples of investments to which the net premium is applied are index funds, such as an S&P 500 fund 304, a bond fund 305, and a fixed income portfolio 306. Other investments 307 may be made as well. A percentage of the gross returns from these investments is deducted to cover fees by the insurance carrier 302 and other loads. The net investment results are reported by the policyholder 301 in its financial statements as the change in cash surrender value of the policy.

The fixed income portfolio 306 provides fixed, or stable, returns by way of a stable value agreement 308 according to the exemplary embodiment. In other words, the fixed income portfolio 306 is actually an investment having a volatile market value, whereby this volatility is reduced by a stable value agreement 308. FIG. 2 illustrates the effect of such a stable value agreement, where a less-volatile book value is guaranteed by the stable value provider. Therefore, in the exemplary embodiment, the insurance carrier 302 pays a monthly fee to the stable value provider (not shown) offering the stable value agreement 308, in return for the stable value provider's stable book value returns for the investments underlying the fixed income portfolio 306.

In the deferred compensation context, the policyholder 301 is an employer that chooses which investments to make with its net premium payment. The choice of investments is made to mimic the growth characteristics of the liabilities of the employer 301 to its employees (not shown). For example, if an employee chooses to have his or her deferred compensation asset exposed to the returns of an S&P 500 fund, the employer 301 may want a portion of its net premium to be invested into the S&P 500 fund 304. On the other hand, if the employer 301 has an obligation to an employee that grows at a fixed rate, the employer may want a portion of its net premium to be invested in the fixed income portfolio 306.

The less-volatile return of the fixed income portfolio 306 is provided by the stable value agreement 308. The stable value agreement 308 of the exemplary embodiment allows the employer to withdraw funds from the fixed income portfolio 306 with unprecedented ease, because the agreement contains provisions that reduce risk associated with the withdrawal for the stable value provider. By reducing risks associated with withdrawals, stable value providers can allow more frequent withdrawals, thereby making the underlying assets liquid. Accordingly, this arrangement provides the employer with the flexibility required to adjust asset allocations in parallel with changing obligations to its employees.

The manner in which the stable value agreement 308, according to an embodiment of the present invention, allows more frequent withdrawals by reducing risk associated with withdrawals will now be described. The stable value agreement 308 guarantees a stable book value on the unstabilized market value returns of the investments underlying the agreement 308. The stabilizing of the market value of the investments underlying the stable value agreement 308 into a book value is shown generally in FIG. 2.

The book value guaranteed by the stable value agreement 308 grows at a rate determined by a crediting rate formula. The crediting rate formula and all formulas herein described may be implemented by a computer. However, one skilled in the art will appreciate that the invention is not limited to the computer arrangement(s) used to implement these formulas. The term “computer” is intended to include any data processing device, such as a desktop computer, a laptop computer, a mainframe computer, a personal digital assistant, a Blackberry, and/or any other device for processing data, whether implemented with electrical and/or magnetic and/or optical and/or biological components, or otherwise. In an embodiment of the present invention, the crediting rate is calculated using the following formula:

CR=(MV/BV)^{1/D}×(1+Y)−1 (1)

CR is the crediting rate in percent, MV is the existing market value of the portfolio, BV is the existing book value of the portfolio, D is the duration of the portfolio, and Y is the current market yield in percent. The floor of the crediting rate is 0%.

The policyholder 301 may be permitted to add to or withdraw from the stable value fixed income portfolio 306 periodically, such as on a monthly basis. This arrangement permits much greater access to funds in the stable value fixed income portfolio 306 than in the conventional arrangement.

To reduce the stable value provider's exposure to risk when the policyholder 301 withdraws funds from the fixed income portfolio 306, the absolute value of any difference between book value and actual value relating to the amounts that are withdrawn, is reduced over time, such as being amortized to zero on a straight-line basis over three years. In the most extreme case, where 100% of the stable value fixed income portfolio 306 is withdrawn, the absolute value of the entire difference between book value and actual value of the withdrawal may be amortized to zero over a period of time.

This process of amortizing the absolute value of the difference between book value and actual value relating to the amounts withdrawn may occur for each withdrawal. In other words, for each withdrawal, a difference between book value and actual value is calculated for the particular withdrawal, and the absolute value of the difference for the particular withdrawal is amortized to zero over its predetermined period beginning on the date of the withdrawal.

Any difference between book value and actual value relating to amounts that remain within the stable value fixed income portfolio 306 after a withdrawal, is amortized on the basis of the crediting rate formula shown as formula (1) above.

In the case of notice of policy surrender, all assets in the stable value fixed income portfolio 306 are sold and reinvested in money market instruments until the cash settlement date, which occurs 180 days after notice of surrender is given.

The value of the stable value agreement at any given time, according to the present invention, is the sum of:
(a) the difference between book value and actual value within the stable value fixed income portfolio 306, and
(b) the unamortized difference between book value and actual value for amounts previously withdrawn from the stable value fixed income portfolio 306.

“(b),” in other words, refers to the aggregation of all remaining unamortized differences between book value and actual value for each previous withdrawal from the fixed income portfolio 306. To summarize, if “(a)” is symbolized by “(BV-MV)” and “(b)” is summarized as “Total Difference,” then the value of the stable value agreement 308 is defined as follows:

Value of Agreement=(BV−MV)+(Total Difference) (2)

The value of the agreement, if positive, indicates the stable value provider's potential liability to the policyholder if a predetermined event occurs, such as surrender of the relevant life insurance policy. To elaborate, if the policyholder 301 undertakes a qualifying surrender of the life insurance policy, the stable value provider is obligated to pay the value of the agreement (equation 2), if such value is positive. However, if such value is negative, the stable value provider is entitled to receive payment in the amount of the value of the agreement (equation 2). In this case, the value of the agreement is an asset, not a liability to the stable value provider.

The value of the agreement defined by equation (2) is different than the conventional definition of the stable value provider's potential liability in two important respects. First, the conventional definition requires the stable value provider to pay the policyholder the book value of the portfolio minus the market value of the portfolio (BV-MV) upon surrender.

In contrast, equation 2 of the present invention includes “Total Difference” as defined above in its calculation of potential amounts due to the policyholder at surrender.

Second, book value (“BV”) used in equation (2) of the present invention is calculated differently than the book value in the conventional definition (BV−MV) after a withdrawal has been made. In the conventional arrangement, the actual amount of a withdrawal is deducted from the book value of the portfolio. In contrast, according to an embodiment of the present invention, the book value of a withdrawal, not the actual amount of the withdrawal, is deducted from the book value of the portfolio. In both cases, however, the actual amount of the withdrawal is deducted from the market value of the portfolio.

For example, assume that the portfolio contains 100 shares, each share having a market value of $1.00 and a book value of $1.10. Therefore, the market value of the portfolio before the withdrawal is $100, and the book value of the portfolio before the withdrawal is $110. According to the conventional arrangement, if the actual amount withdrawn is $20, i.e., 20 shares are sold at market value, then the book value after the withdrawal is $110−(20*$1.00)=$90. In contrast, according to the present invention, if the same 20 shares are sold, then the book value after the withdrawal is $110−(20*$1.10)=$88. In both cases, however, the market value is reduced to $80.

Another withdrawal example will further clarify these points and will be described with reference to Tables I-IV. Assume that the book value of the fixed income portfolio 306 is $100,000 and that the market value of the fixed income portfolio 306 is $90,000 at some particular time prior to a withdrawal. Therefore, the initial scenario is as shown in Table I.

TABLE I
Scenario Prior to Initial Withdrawal

| | An Embodiment of the | |
|---|---|---|
| | Present Invention | Conventional Arrangement |
| BV of Portfolio | $100,000 | $100,000 |
| MV of Portfolio | $90,000 | $90,000 |
| Potential Liability | $10,000 | $10,000 |

Although calculated differently, both this embodiment of the present invention and the conventional arrangement report the same potential liability for the stable value provider at this point in time. Potential liability, i.e., the “Value of Agreement,” according to an embodiment of the present invention, is calculated according to equation (2). Potential liability in the conventional arrangement is calculated strictly as book value (“BV”) of the portfolio minus market value (“MV”) of the portfolio. Since “Total Difference” in equation (2) is zero at this point, and both book values are equal, both potential liabilities are equal.

With reference to Table II below, a withdrawal of $9,000 (actual amount) is withdrawn from the fixed income portfolio 306. According to an embodiment of the present invention, $9,000 is 10% of the MV of the portfolio, and, therefore, the BV of the withdrawal is 10% of the $100,000 BV of the portfolio, or $10,000. Accordingly, this withdrawal results in a book value of the portfolio 306 dropping to $90,000. The market value of the portfolio 306 drops to $81,000 because the actual amount of the withdrawal is $9,000. The difference between the decline in book value and the decline in market value is $1,000. Stated differently, the difference between the book value of the withdrawal and the actual value of the withdrawal is $1,000. This $1,000 difference is an amount related to a liability resulting from the withdrawal for the stable value provider. This difference may be set to amortize to zero over a period of time, such as three years on a straight-line basis, thereby reducing the stable value provider's potential liability with time. In the conventional arrangement, both the market value of the portfolio and the book value of the portfolio are reduced by the $9,000 actual amount of the withdrawal.

TABLE II
Scenario After First Withdrawal

| | An Embodiment of the | Conventional |
|---|---|---|
| | Present Invention | Arrangement |
| BV of Withdrawal | $10,000 | N/A |
| Actual Withdrawal | $9,000 | $9,000 |
| Amount | | |
| Difference Between BV | $1,000 | N/A |
| and MV of Initial | | |
| Withdrawal | | |
| BV of Portfolio | $90,000 | $91,000 |
| MV of Portfolio | $81,000 | $81,000 |
| Potential Liability | $10,000 | $10,000 |

Based upon the scenario shown in Table II and according to an embodiment of the present invention, the value of the agreement (Potential Liability), using formula (2), is ($90,000−$81,000)+$1,000=$10,000. If a qualified surrender takes place, the stable value provider is obligated to pay the value of the agreement at the time of the qualified surrender. According to the conventional arrangement, the potential liability is $91,000−$81,000=$10,000. Therefore, at this point in time, prior to amortization of the $1,000 difference, both methods report the same potential liability.

Referring now to Table III, below, assume that a period of time passes, such that the market value of the portfolio is now $95,000 and that the difference between the book value and the actual value of the initial withdrawal has amortized to $750. Further, assume that during this period of time, the corresponding book values have moderately increased.

TABLE III
Scenario Prior to Second Withdrawal

| | An Embodiment of the | Conventional |
|---|---|---|
| | Present Invention | Arrangement |
| Unamortized Difference | $750 | N/A |
| Remaining Between BV | | |
| and MV of Initial | | |
| Withdrawal | | |
| BV of Portfolio | $91,000 | $92,000* |
| MV of Portfolio | $95,000 | $95,000 |
| Potential Liability | −$3,250 | −$3,000 |

The “*” in Table III indicates that the BV in the conventional arrangement should actually be a little higher because it was greater than the BV of the present invention and, consequently, would have accrued additional interest. However, for simplicity, this amount is ignored.

Table III also indicates a negative potential liability, which is actually a potential asset for the stable value provider. In other words, if the policy is surrendered, the stable value provider is entitled to $3,250 according to an embodiment of the present invention and $3,000 according to the conventional arrangement. The $250 difference is due to the amortization of the difference between book value and actual value of the initial withdrawal, which is not included in the conventional arrangement. Again, potential liability according to an embodiment of the present invention is calculated using equation (2) as follows: ($91,000−$95,000)+$750=negative $3,250. According to the conventional arrangement, potential liability is $92,000−$95,000=negative $3,000.

Referring now to Table IV, below, assume that the policyholder withdraws $9,500 (actual amount) from the fund 306. According to an embodiment of the present invention, $9,500 is 10% of the $95,000 MV of the portfolio, and, therefore, the BV of the withdrawal is 10% of the $91,000 BV of the portfolio, or $9,100. The book value of the portfolio 306 after the second withdrawal is $91,000−$9,100=$81,900, and the market value of the portfolio 306 after the withdrawal is $95,000−$9,500=$85,500. The difference between the decrease in book value and the decrease in market value of the portfolio is negative $400. Stated differently, the difference between the book value of the withdrawal and the actual value of the withdrawal is negative $400. This negative $400 difference is an amount related to an asset resulting from the withdrawal for the stable value provider. According to an embodiment of the present invention, this difference is set to amortize to zero over a period of time, such as three years on a straight-line basis. In the conventional arrangement, both the market value of the portfolio and the book value of the portfolio are reduced by the $9,500 actual amount of the withdrawal.

TABLE IV
Scenario After Second Withdrawal

| | An Embodiment of the | Conventional |
|---|---|---|
| | Present Invention | Arrangement |
| Unamortized Difference | $750 | N/A |
| Remaining Between BV | | |
| and MV from Initial | | |
| Withdrawal | | |
| BV of Second | $9,100 | N/A |
| Withdrawal | | |
| Actual Amount of Second | $9,500 | $9,500 |
| Withdrawal | | |
| Difference Between BV | −$400 | N/A |
| and MV of Second | | |
| Withdrawal | | |
| BV of Portfolio | $81,900 | $82,500 |
| MV of Portfolio | $85,500 | $85,500 |
| Potential Liability | −$3,250 | −$3,000 |

Based upon the scenario shown in Table IV and according to the present invention, the total unamortized difference from all withdrawals is $750−$400=$350. The value of the agreement (Potential Liability), using formula (2), at this time is then ($81,900−$85,500)+$350, or negative $3,250, meaning that the stable value provider would be owed $3,250 if the policy is surrendered. According to the conventional arrangement, the potential liability is $82,500−$85,500, or negative $3,000.

As can be seen, an embodiment of the present invention reduces absolute values of the differences between book value and actual value of withdrawals with time. Further, an embodiment of the present invention combines remaining unamortized differences between book value and actual value (both positive and negative) of withdrawals and incorporates them into the value of the agreement, tending to balance out the effect of multiple withdrawals. Accordingly, the risk involved in allowing withdrawals is reduced, and withdrawals can be allowed more frequently. Consequently, policyholders have a stable value investment that keeps their assets liquid.

It is to be understood that the exemplary embodiments are merely illustrative of the present invention and that many variations of the above-described embodiment and example can be devised by one skilled in the art without departing from the scope of the invention. For instance, although the exemplary embodiments are discussed in the deferred compensation context, one skilled in the art will appreciate that the scope of the invention includes any investment scenario where risk is involved with withdrawals. It is therefore intended that all such variations be included within the scope of the following claims and their equivalents.

What is claimed is:

1. A method for reducing risk associated with a withdrawal from an investment, the method comprising:
determining an amount related to a liability or asset resulting from the withdrawal; and
incorporating at least a portion of the amount into a liability or asset related to the investment.

2. The method of claim 1 wherein the amount is a difference between a book value and an actual value of the withdrawal.

3. The method of claim 1 wherein the liability or asset related to the investment is a difference between a book value and a market value of the investment after the withdrawal.

4. The method of claim 1 further comprising:
reducing an absolute value of the amount over a predetermined period.

5. The method of claim 1 further comprising:
amortizing the amount over a predetermined period.

6. The method of claim 1 further comprising:
amortizing the amount over three years on a straight-line basis.

7. The method of claim 1 wherein the incorporating results in a value and the method further comprises:
making a payment in an amount of the value, if positive, upon the occurrence of a predetermined event; and
receiving a payment in an amount of the value, if negative, upon the occurrence of the predetermined event.

8. The method of claim 7 wherein the predetermined event is a surrender.

9. A method for providing a return for an investment, the return having less volatility than an actual value of the investment, and the method comprising:
allowing an amount to be withdrawn from the investment;
calculating a difference between a book value and a market value of the amount withdrawn from the investment;
calculating an agreed value as: (BV−MV)+(DIFF), wherein BV is a book value of the investment, MV is a market value of the investment, and DIFF includes at least a portion of the difference between the book value and the actual value of the amount withdrawn from the investment; and
promising to pay the agreed value upon the occurrence of a predetermined event, if the agreed value is positive.

10. The method of claim 9 wherein BV is a book value of the investment after the amount has been withdrawn, and MV is a market value of the investment after the amount has been withdrawn.

11. The method of claim 9 further comprising:
receiving a promise to pay the agreed value upon the occurrence of a predetermined event, if the agreed value is negative.

12. The method of claim 9 further comprising:
calculating BV by subtracting: (a) the book value of the amount withdrawn from (b) the book value of the investment prior to withdrawal of the amount; and
calculating MV by subtracting (a) the actual value of the amount withdrawn from (b) the market value of the investment prior to withdrawal of the amount.

13. The method of claim 9 further comprising:
reducing an absolute value of the difference between the book value and the actual value of the amount withdrawn from the investment over a predetermined period.

14. The method of claim 9 further comprising:
amortizing an absolute value of the difference over a predetermined period.

15. The method of claim 9 further comprising:
amortizing an absolute value of the difference over three years on a straight-line basis.

16. The method of claim 9 wherein the predetermined event is a surrender.

17. The method of claim 9 further comprising:
calculating a remaining difference by reducing an absolute value of the difference between the book value and the actual value of the amount withdrawn from the investment;
allowing a second amount to be withdrawn from the investment;
calculating a second difference between a book value and an actual value of the second amount withdrawn from the investment; and
calculating DIFF as a sum of the remaining difference and the second difference,
wherein BV is calculated at least in part by subtracting: (a) the book value of the second amount withdrawn from (b) the book value of the investment prior to withdrawal of the second amount, and
wherein MV is calculated at least in part by subtracting (a) the actual value of the second amount withdrawn from (b) the market value of the investment prior to withdrawal of the second amount.

18. A method for providing a return for an investment, the return having less volatility than a market value of the investment, and the method comprising:
calculating, with a computer, a first difference between a book value and the market value of the investment;
calculating, with the computer, a second difference between the book value and an actual amount withdrawn from the investment;
combining the second difference with the first difference, the combining resulting in a combined value; and
promising to pay the combined value upon an occurrence of a predetermined event, if the combined value is positive.

19. The method of claim 18 further comprising:
receiving a promise to pay the value upon the occurrence of the predetermined event, if the combined value is negative.

20. The method of claim 18 further comprising:
reducing an absolute value of the second difference over a predetermined period.

21. The method of claim 18 further comprising:
amortizing the absolute value of the second difference over a predetermined period.

22. The method of claim 18 further comprising:
amortizing the absolute value of the second difference over three years on a straight-line basis.

23. The method of claim 18 wherein the predetermined event is a surrender.
